(19) United States
(12) Patent Application Publication
(10) Pub. No.: US 2026/0092820 A1
(43) Pub. Date: Apr. 2, 2026

(54) METHOD AND SYSTEM FOR DETECTING ERRORS IN TEMPERATURE READINGS IN GAS TURBINE ENGINES

(71) Applicant: Solar Turbines Incorporated, San Diego, CA (US)

(72) Inventors: David McConnell Higdon, San Diego, CA (US); Christian Marcus Cook, Waxhaw, NC (US); Samaneh Nobakht, Chula Vista (CA); Sergey Gurvich, Vista, CA (US)

(73) Assignee: Solar Turbines Incorporated, San Diego, CA (US)

(21) Appl. No.: 18/903,327

(22) Filed: Oct. 1, 2024

(51) Int. Cl. G01K 15/00; G01K 1/02; G01K 1/024; G01K 1/14; G01K 3/14; G01K 7/02; G01M 15/14

(52) U.S. Cl. CPC G01K 15/007; G01K 1/024; G01K 1/026; G01K 1/14; G01K 3/14; G01K 7/02; G01M 15/14

(57) ABSTRACT

A method for detecting errors in temperature readings at a section of a gas turbine engine is described. The method includes obtaining a plurality of first average temperatures and a plurality of second average temperatures respectively from a first module and a second module for multiple time intervals. The method further includes determining a drift in values of one of the plurality of first average temperatures and the plurality of second average temperatures in comparison to corresponding values of the other of the plurality of first average temperatures and the plurality of second average temperatures over the multiple time intervals to detect that one of the first module or the second module is erroneous.

### TECHNICAL FIELD

The present disclosure relates to a method and system for detecting errors in temperature readings in a gas turbine engine. More particularly, the present disclosure relates to determining measurement drift of input modules employed to read temperature signals at a section of a gas turbine engine.

### BACKGROUND

A working temperature in a gas turbine engine, e.g., in a section of the gas turbine engine, is generally monitored to ensure a reliable operation of the gas turbine engine. An inaccurate monitoring or measurement of the temperature in the gas turbine engine, e.g., at the section, may cause one or more parameters of the gas turbine engine to function in an unintended manner, unduly straining various parts of the gas turbine engine, and reducing an overall engine life and/or engine efficiency. As an example, erroneously detecting a relatively low temperature at a combustor section of the gas turbine engine when the temperature at the combustor section is actually relatively high may cause increased fueling into the gas turbine engine, potentially causing erratic or improper engine operation.

Chinese Patent Publication No. CN103195583B describes a method for monitoring and protecting the combustion of gas turbine by adopting gas exhaust temperature dispersity. The method comprises installing a plurality of temperature measuring thermocouples at the turbine air exhaust end of the gas turbine, and acquiring a gas exhaust temperature dispersity through temperature measuring thermocouple collecting signals by adopting a multi-dimensional space cosine law, thereby predicting the combustion stability of a combustion chamber indirectly.

### SUMMARY

In an aspect, the present disclosure relates to a method for detecting errors in temperature readings at a section of a gas turbine engine. The method includes detecting, at a first set of thermocouples coupled to a first module of a first temperature measurement unit, first corresponding temperatures at a first location of the section of the gas turbine engine during a time interval and deriving, via the first module, a first average temperature based on the first corresponding temperatures for the time interval. The method further includes detecting, at a second set of thermocouples coupled to a second module of a second temperature measurement unit, second corresponding temperatures at a second location of the section of the gas turbine engine during the time interval and deriving, via the second module, a second average temperature based on the second corresponding temperatures for the time interval. Further, the method includes obtaining a plurality of first average temperatures and a plurality of second average temperatures respectively from the first module and the second module for multiple time intervals. The method further includes determining a drift in values of one of the plurality of first average temperatures and the plurality of second average temperatures in comparison to corresponding values of the other of the plurality of first average temperatures and the plurality of second average temperatures over the multiple time intervals to detect that one of the first module or the second module is erroneous.

In another aspect, the present disclosure relates to a method for detecting errors in temperature readings at a section of a gas turbine engine. The method includes detecting, at a first set of thermocouples coupled to a first module of a first temperature measurement unit, first corresponding temperatures at a first location of the section of the gas turbine engine during a time interval and deriving, via the first module, a first average temperature based on the first corresponding temperatures for the time interval. The method further includes detecting, at a second set of thermocouples coupled to a second module of a second temperature measurement unit, second corresponding temperatures at a second location of the section of the gas turbine engine during the time interval and deriving, via the second module, a second average temperature based on the second corresponding temperatures for the time interval. Further, the method includes obtaining, by a controller, a plurality of first average temperatures and a plurality of second average temperatures respectively from the first module and the second module for multiple time intervals. The method further includes determining, by the controller, a drift in values of one of the plurality of first average temperatures and the plurality of second average temperatures in comparison to corresponding values of the other of the plurality of first average temperatures and the plurality of second average temperatures over the multiple time intervals to detect that one of the first module or the second module is erroneous. The determination of the drift includes computing, by the controller, corresponding differences between the plurality of first average temperatures and the plurality of second average temperatures. The determination further includes determining, by the controller, that a predetermined number of corresponding differences are incrementally increasing with every subsequent time interval and determining, by the controller, an incremental decrease in values of one of the plurality of first average temperatures and the plurality of second average temperatures with every subsequent time interval.

In yet another aspect, the present disclosure relates to a system for detecting errors in temperature readings at a section of a gas turbine engine. The system includes at least one first temperature measurement unit having a first module and a first set of thermocouples coupled to the first module. The first set of thermocouples is configured to detect first corresponding temperatures at a first location of the section of the gas turbine engine during a time interval and the first module is configured to derive a first average temperature based on the first corresponding temperatures for the time interval. The system further includes at least one second temperature measurement unit having a second module and a second set of thermocouples coupled to the second module. The second set of thermocouples is configured to detect second corresponding temperatures at a second location of the section of the gas turbine engine during the time interval and the second module is configured to derive a second average temperature based on the second corresponding temperatures for the time interval. The system further includes a controller coupled to the at least one first temperature measurement unit and the at least one second temperature measurement unit. The controller is configured to obtain a plurality of first average temperatures and a plurality of second average temperatures respectively from the first module and the second module for multiple time intervals and determine a drift in values of one of the plurality of first average temperatures and the plurality of second average temperatures in comparison to corresponding values of the other of the plurality of first average temperatures and the plurality of second average temperatures over the multiple time intervals to detect that one of the first module or the second module is erroneous.

### BRIEF DESCRIPTION OF THE DRAWINGS

FIG. 1 is a schematic view of an exemplary turbine engine, in accordance with an embodiment of the present disclosure;

FIG. 2 is an exemplary system for detecting errors in temperature readings at a section of the turbine engine of FIG. 1, in accordance with an embodiment of the present disclosure; and

FIG. 3 is an exemplary method for detecting the errors in temperature readings at the section of the turbine engine of FIG. 1, in accordance with an embodiment of the present disclosure.

### DETAILED DESCRIPTION

Reference will now be made in detail to specific embodiments or features, examples of which are illustrated in the accompanying drawings. Wherever possible, the same reference numbers will be used throughout the drawings to refer to the same or the like parts.

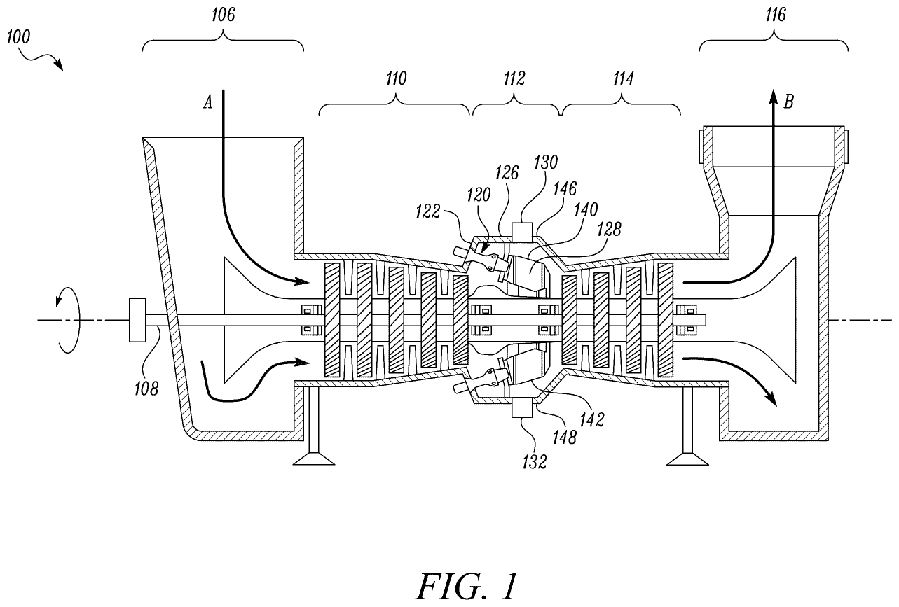

Referring to FIG. 1, a schematic illustration of an exemplary turbine engine 100 is provided. The turbine engine 100 may be a gas turbine engine. The turbine engine 100 may be associated with applications in a variety of machines. For example, the turbine engine 100 may be used to drive a compressor and/or may be used as a power source for a stationary machine, such as a generator that produces electrical power. The turbine engine 100 may alternatively be applied as a prime mover of a machine, such as a mobile machine.

As shown in FIG. 1, the turbine engine 100 includes an intake section 106, a shaft 108, a compressor section 110, a combustor section 112, a turbine section 114, and an exhaust section 116. In layout, the combustor section 112 may take a position in between the compressor section 110 and the turbine section 114, with the shaft 108 extending through each of the compressor section 110, the combustor section 112, and the turbine section 114. Although this configuration of the turbine engine 100 is discussed above, various other configurations of the turbine engine 100, now known or in the future developed, may be contemplated and applied by someone skilled in the art.

In operation, air is drawn into the compressor section 110 through the intake section 106 (see direction A, FIG. 1), and is pressurized and compressed by the compressor section 110. The compressed air, generated by the compressor section 110, may be directed towards the combustor section 112. The combustor section 112 may receive and mix the compressed air with a fuel (such as a gaseous fuel, for example, Natural Gas) to form an air-fuel mixture, and, thereafter, combust said air-fuel mixture for production of motive power.

To this end, the combustor section 112 includes a fuel injector assembly 120 and a combustor 122, with the fuel for mixing with the compressed air being provided by the fuel injector assembly 120. In one example, the fuel injector assembly 120 is configured to inject a quantity of fuel into a stream of inflowing compressed air received from the compressor section 110, causing the fuel to mix with the inflowing compressed air and form the air-fuel mixture. The combustor 122 includes a combustor wall 126 that houses a combustion chamber 128 of the turbine engine 100. The combustion chamber 128 may receive the air-fuel mixture for combustion, and combustion of the air-fuel mixture may generate hot gases that may expand and move at a relatively high speed into the turbine section 114. Working temperatures within the combustion chamber 128 or at the combustor section 112 of the turbine engine 100 may be relatively high during operations.

The turbine section 114 is configured to receive the hot gases of combustion from the combustor section 112 and facilitates flow of the expanding hot gas during operation. The turbine section 114 may include multiple turbine stages for the inflowing hot gas, with each stage being associated with an increase in a speed of an exit of the hot gases of combustion through the exhaust section 116 (see direction B, FIG. 1).

In accordance with various embodiments, the turbine engine 100 includes at least one first temperature measurement unit 130 and at least one second temperature measurement unit 132 for detecting errors in temperature readings at a section of the turbine engine 100. For example, the section may correspond to any one of the intake section 106, the compressor section 110, the combustor section 112, the turbine section 114, the exhaust section 116 or any other section of the turbine engine 100, e.g., across or at any point of which temperatures may be redundant or same or within a range. The first temperature measurement unit 130 and the second temperature measurement unit 132 may be installed at different locations of the same section of the turbine engine 100. For example, as shown, the first temperature measurement unit 130 is installed diagonally opposite to the second temperature measurement unit 132 on the combustor wall 126. The components and functioning of the first temperature measurement unit 130 and the second temperature measurement unit 132 will be described in detail in the forthcoming description.

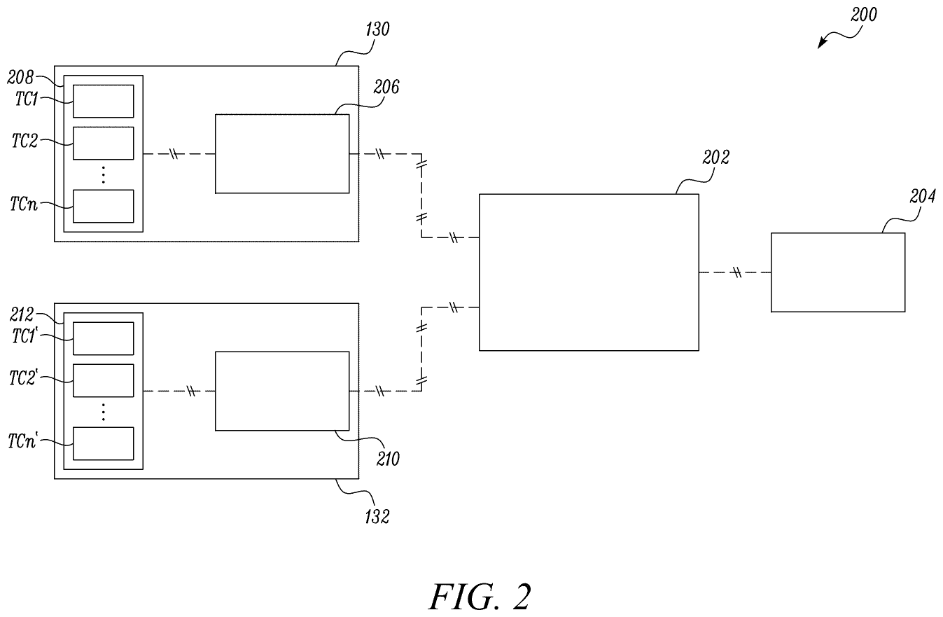

FIG. 2 describes a system 200 for detecting errors in temperature readings at the section (for example, the combustor section 112) of the turbine engine 100. The system 200 includes the first temperature measurement unit 130, the second temperature measurement unit 132, a controller 202, and a display device 204. The controller 202 is operatively coupled to the first temperature measurement unit 130, the second temperature measurement unit 132, and the display device 204.

The first temperature measurement unit 130 includes a first module 206 and a first set of thermocouples 208 coupled to the first module 206. For example, the coupling between the first set of thermocouples 208 and the first module 206 may be a wired connection. The first set of thermocouples 208 may include one or more thermocouples TC1, TC2, . . . TCn arranged at a first location of the section of the turbine engine 100. For example, although not limited, when the section of the turbine engine 100 corresponds to the combustor section 112, the first location may correspond to a first predetermined area 140 (shown in FIG. 1) of the combustor section 112. The first set of thermocouples 208 are configured to detect first corresponding temperatures at the first location of the section of the turbine engine 100 during a time interval (T1) and generate signals corresponding to the detected first temperatures at the first location.

The first module 206 is configured to obtain the signals generated by the first set of thermocouples 208 and derive a first average temperature (FT1) based on the first corresponding temperatures for the time interval (T1). The first module 206 can be any thermocouple module that converts the signals received from the first set of thermocouples 208 into a readable format. The first module 206 may be arranged at any location of the turbine engine 100. For example, the first module 206 may be arranged on a first side 146 (shown in FIG. 1) of the combustor wall 126 of the combustor section 112.

The second temperature measurement unit 132 includes a second module 210 and a second set of thermocouples 212 coupled to the second module 210. For example, the coupling between the second set of thermocouples 212 and the second module 210 may be a wired connection. The second set of thermocouples 212 may include one or more thermocouples TC1′, TC2′, . . . TCn′ arranged at a second location of the section of the turbine engine 100. For example, although not limited, when the section of the turbine engine 100 corresponds to the combustor section 112, the second location may correspond to a second predetermined area 142 (shown in FIG. 1) of the combustor section 112. The second set of thermocouples 212 are configured to detect second corresponding temperatures at the second location of the section of the turbine engine 100 during the time interval (T1) and generate signals corresponding to the detected second temperatures at the second location.

The second module 210 is configured to obtain the signals generated by the second set of thermocouples 212 and derive a second average temperature (ST1) based on the second corresponding temperatures for the time interval (T1). The second module 210 can be any thermocouple module that converts the signals received from the second set of thermocouples 212 into a readable format. The second module 210 may be arranged at any location of the turbine engine 100. For example, the second module 210 may be arranged on a second side 148 (shown in FIG. 1) of the combustor wall 126 of the combustor section 112.

In accordance with various embodiments, the first location and the second location are determined such that first working temperatures at the first location against which the first corresponding temperatures are detected and second working temperatures at the second location against which the second corresponding temperatures are detected lie within a preset working temperature range during a normal working of the turbine engine 100. The preset working temperature range may be any range defined by a user. For example, the preset working temperature range may lie between 1000 degree Celsius to 1200 degree Celsius. In the embodiment discussed above, the first predetermined area 140 and the second predetermined area 142 are adjacent to the fuel injector assembly 120 of the combustor 122, thereby having working temperatures within the preset working temperature range.

The controller 202 is configured to obtain (e.g., by computation) a plurality of first average temperatures (FT1, FT2, . . . FTn) and a plurality of second average temperatures (ST1, ST2, . . . STn) respectively from the first module 206 and the second module 210 for multiple time intervals (T1, T2, . . . Tn). The controller 202 is configured to determine a drift in values of one of the plurality of first average temperatures (FT1, FT2, . . . FTn) and the plurality of second average temperatures (ST1, ST2, . . . STn) in comparison to corresponding values of the other of the plurality of first average temperatures (FT1, FT2, . . . FTn) and the plurality of second average temperatures (ST1, ST2, . . . STn) over the multiple time intervals (T1, T2, . . . Tn) to detect that one of the first module 206 or the second module 210 is erroneous.

To this end, the controller 202 is configured to determine the drift by computing corresponding differences (D1, D2, . . . Dn) between the plurality of first average temperatures (FT1, FT2, . . . FTn) and the plurality of second average temperatures (ST1, ST2, . . . STn). For example, the difference D1 represents the difference between the first average temperature (FT1) and the second average temperature (ST1). The controller 202 is configured to determine that a predetermined number of corresponding differences (D1, D2, . . . Dn) are incrementally increasing with every subsequent time interval (T1, T2, . . . Tn). For example, the controller 202 may determine that the difference D2 is greater than the difference D1.

Further, the controller 202 is configured to determine an incremental decrease in values of one of the plurality of first average temperatures (FT1, FT2, . . . FTn) and the plurality of second average temperatures (ST1, ST2, . . . STn) with every subsequent time interval (T1, T2, . . . Tn). In accordance with various embodiments, the drift in values of one of the plurality of first average temperatures (FT1, FT2, . . . FTn) and the plurality of second average temperatures (ST1, ST2, . . . STn) is determined when the values of one of the plurality of first average temperatures (FT1, FT2, . . . FTn) and the plurality of second average temperatures (ST1, ST2, . . . STn) decrease with every subsequent time interval (T1, T2, . . . Tn) and the values of the other of the plurality of first average temperatures (FT1, FT2, . . . FTn) and the plurality of second average temperatures (ST1, ST2, . . . STn) remains within a predefined threshold range with every subsequent time interval (T1, T2, . . . Tn). For example, the controller 202 may determine that the values of the first average temperatures (FT1, FT2,. . . FTn) decrease with every subsequent time interval (T1, T2, . . . Tn) and the values of the plurality of second average temperatures (ST1, ST2, . . . STn) remains within the predefined threshold range with every subsequent time interval (T1, T2, . . . Tn). In accordance with various embodiments, the predefined threshold range can be any range defined by a user. For example, the predefined threshold range may correspond to 1000 degree Celsius to 1200 degree Celsius.

The controller 202 is configured to control the display device 204 to indicate that the first module 206 is erroneous when the plurality of first average temperatures (FT1, FT2, . . . FTn) includes the drift or indicates that the second module 210 is erroneous when the plurality of second average temperatures (ST1, ST2, . . . STn) includes the drift. In some embodiments, the display device 204 may be installed close to or in proximity to the turbine engine 100. In some embodiments, the display device 204 may be located at a remote location from the turbine engine 100.

The controller 202 may be one or more processor, a microprocessor, a microcontroller, an electronic control module (ECM), an electronic control unit (ECU), or any other suitable means for determining the drift. The controller 202 may be implemented using one or more controller technologies, such as Application Specific Integrated Circuit (ASIC), Reduced Instruction Set Computing (RISC) technology, Complex Instruction Set Computing (CISC) technology or any other similar technology now known or developed in the future.

### INDUSTRIAL APPLICABILITY

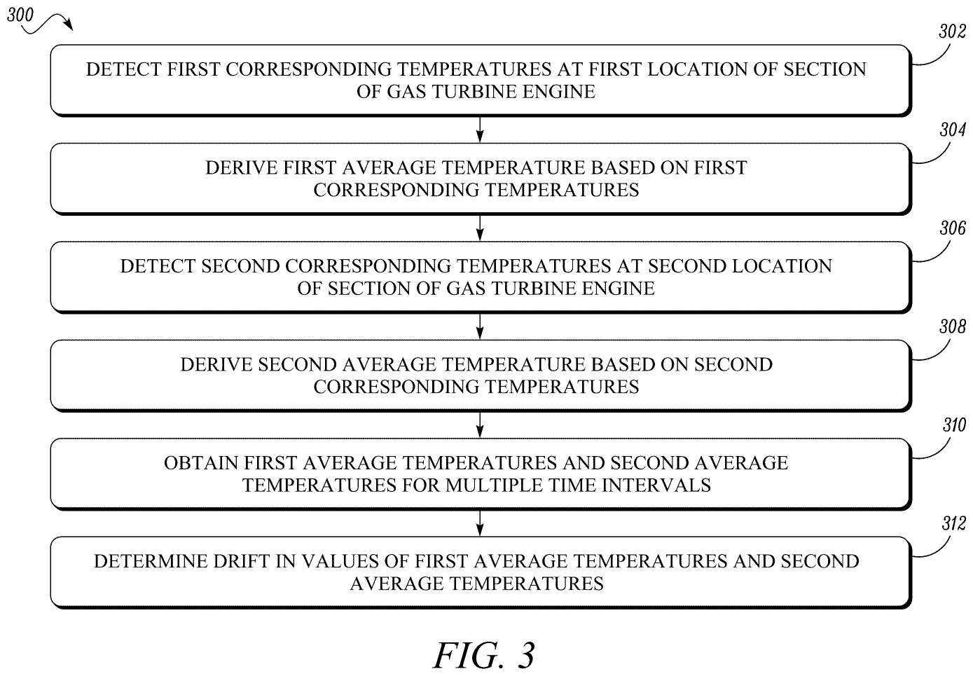

FIG. 3 describes an exemplary method 300 for detecting the errors in temperature readings at the section of the turbine engine 100. The method 300 includes detecting, at the first set of thermocouples 208 coupled to the first module 206 of the first temperature measurement unit 130, the first corresponding temperatures at the first location of the section of the turbine engine 100 during the time interval (T1) at block 302. The method further includes, at block 304, deriving, via the first module 206, the first average temperature (FT1) based on the first corresponding temperatures for the time interval (T1).

The method 300 further includes, at block 306, detecting, at the second set of thermocouples 212 coupled to the second module 210 of the second temperature measurement unit 132, the second corresponding temperatures at the second location of the section of the turbine engine 100 during the time interval (T1). At block 308, the method 300 further includes deriving, via the second module 210, the second average temperature (ST1) based on the second corresponding temperatures for the time interval (T1).

At block 310, the method 300 includes obtaining the plurality of first average temperatures (FT1, FT2, . . . FTn) and the plurality of second average temperatures (ST1, ST2, . . . STn) respectively from the first module 206 and the second module 210 for multiple time intervals (T1, T1, . . . Tn).

The method further includes, at block 312, determining the drift in values of one of the plurality of first average temperatures (FT1, FT2, . . . FTn) and the plurality of second average temperatures (ST1, ST2, . . . STn) in comparison to corresponding values of the other of the plurality of first average temperatures (FT1, FT2, . . . FTn) and the plurality of second average temperatures (ST1, ST2, . . . STn) over the multiple time intervals (T1, T1, . . . Tn) to detect that one of the first module 206 or the second module 210 is erroneous.

The system 200 and the method 300 of the present disclosure ensure reliable operations of the turbine engine 100 by accurately detecting errors in the temperature readings at any section of the turbine engine 100. By employing at least two temperature measurement units 130, 132 at two different locations of a same section of the turbine engine 100 and determining the drift in values obtained from the temperature measurement units 130, 132 over multiple time intervals (T1, T2, . . . Tn), the erroneous module 206, 210 can be timely and accurately determined for repairs and/or replacements, thereby preventing erratic or improper engine operation.

It will be apparent to those skilled in the art that various modifications and variations can be made to the method and/or system of the present disclosure without departing from the scope of the disclosure. Other embodiments will be apparent to those skilled in the art from consideration of the specification and practice of the method and/or system disclosed herein. It is intended that the specification and examples be considered as exemplary only, with a true scope of the disclosure being indicated by the following claims and their equivalent.

What is claimed is:

1. A method for detecting errors in temperature readings at a section of a gas turbine engine, the method comprising:
detecting, at a first set of thermocouples coupled to a first module of a first temperature measurement unit, first corresponding temperatures at a first location of the section of the gas turbine engine during a time interval;
deriving, via the first module, a first average temperature based on the first corresponding temperatures for the time interval;
detecting, at a second set of thermocouples coupled to a second module of a second temperature measurement unit, second corresponding temperatures at a second location of the section of the gas turbine engine during the time interval;
deriving, via the second module, a second average temperature based on the second corresponding temperatures for the time interval;
obtaining a plurality of first average temperatures and a plurality of second average temperatures respectively from the first module and the second module for multiple time intervals; and
determining a drift in values of one of the plurality of first average temperatures and the plurality of second average temperatures in comparison to corresponding values of the other of the plurality of first average temperatures and the plurality of second average temperatures over the multiple time intervals to detect that one of the first module or the second module is erroneous.

2. The method of claim 1, wherein determining the drift includes:
computing corresponding differences between the plurality of first average temperatures and the plurality of second average temperatures;
determining that a predetermined number of corresponding differences are incrementally increasing with every subsequent time interval; and
determining an incremental decrease in values of one of the plurality of first average temperatures and the plurality of second average temperatures with every subsequent time interval.

3. The method of claim 1, wherein the drift in values of one of the plurality of first average temperatures and the plurality of second average temperatures is determined when the values of one of the plurality of first average temperatures and the plurality of second average temperatures decrease with every subsequent time interval and the values of the other of the plurality of first average temperatures and the plurality of second average temperatures remains within a predefined threshold range with every subsequent time interval.

4. The method of claim 1, further including:
indicating, on a display device, that the first module is erroneous when the plurality of first average temperatures includes the drift; and
indicating, on the display device, that the second module is erroneous when the plurality of second average temperatures includes the drift.

5. The method of claim 1, wherein the first location is different from the second location.

6. The method of claim 1, wherein first working temperatures at the first location against which the first corresponding temperatures are detected and second working temperatures at the second location against which the second corresponding temperatures are detected lie within a preset working temperature range during a normal working of the gas turbine engine.

7. The method of claim 1, wherein the section of the gas turbine engine corresponds to a combustor section or an intake section of the gas turbine engine.

8. A method for detecting errors in temperature readings at a section of a gas turbine engine, the method comprising:
detecting, at a first set of thermocouples coupled to a first module of a first temperature measurement unit, first corresponding temperatures at a first location of the section of the gas turbine engine during a time interval;
deriving, via the first module, a first average temperature based on the first corresponding temperatures for the time interval;
detecting, at a second set of thermocouples coupled to a second module of a second temperature measurement unit, second corresponding temperatures at a second location of the section of the gas turbine engine during the time interval;
deriving, via the second module, a second average temperature based on the second corresponding temperatures for the time interval;
obtaining, by a controller, a plurality of first average temperatures and a plurality of second average temperatures respectively from the first module and the second module for multiple time intervals; and
determining, by the controller, a drift in values of one of the plurality of first average temperatures and the plurality of second average temperatures in comparison to corresponding values of the other of the plurality of first average temperatures and the plurality of second average temperatures over the multiple time intervals to detect that one of the first module or the second module is erroneous, wherein determining the drift includes:
computing, by the controller, corresponding differences between the plurality of first average temperatures and the plurality of second average temperatures;
determining, by the controller, that a predetermined number of corresponding differences are incrementally increasing with every subsequent time interval; and
determining, by the controller, an incremental decrease in values of one of the plurality of first average temperatures and the plurality of second average temperatures with every subsequent time interval.

9. The method of claim 8, wherein the drift in values of one of the plurality of first average temperatures and the plurality of second average temperatures is determined when the values of one of the plurality of first average temperatures and the plurality of second average temperatures decrease with every subsequent time interval and the values of the other of the plurality of first average temperatures and the plurality of second average temperatures remains within a predefined threshold range with every subsequent time interval.

10. The method of claim 8, further including:
indicating, on a display device, that the first module is erroneous when the plurality of first average temperatures includes the drift; and
indicating, on the display device, that the second module is erroneous when the plurality of second average temperatures includes the drift.

11. The method of claim 8, wherein the first location is different from the second location.

12. The method of claim 8, wherein first working temperatures at the first location against which the first corresponding temperatures are detected and second working temperatures at the second location against which the second corresponding temperatures are detected lie within a preset working temperature range during a normal working of the gas turbine engine.

13. The method of claim 8, wherein the section of the gas turbine engine corresponds to a combustor section or an intake section of the gas turbine engine.

14. A system for detecting errors in temperature readings at a section of a gas turbine engine, the system comprising:
at least one first temperature measurement unit having a first module and a first set of thermocouples coupled to the first module, the first set of thermocouples configured to detect first corresponding temperatures at a first location of the section of the gas turbine engine during a time interval and the first module configured to derive a first average temperature based on the first corresponding temperatures for the time interval;
at least one second temperature measurement unit having a second module and a second set of thermocouples coupled to the second module, the second set of thermocouples configured to detect second corresponding temperatures at a second location of the section of the gas turbine engine during the time interval and the second module configured to derive a second average temperature based on the second corresponding temperatures for the time interval; and
a controller coupled to the at least one first temperature measurement unit and the at least one second temperature measurement unit, the controller configured to:
obtain a plurality of first average temperatures and a plurality of second average temperatures respectively from the first module and the second module for multiple time intervals; and
determine a drift in values of one of the plurality of first average temperatures and the plurality of second average temperatures in comparison to corresponding values of the other of the plurality of first average temperatures and the plurality of second average temperatures over the multiple time intervals to detect that one of the first module or the second module is erroneous.

15. The system of claim 14, wherein the controller is configured to determine the drift by:
computing corresponding differences between the plurality of first average temperatures and the plurality of second average temperatures;
determining that a predetermined number of corresponding differences are incrementally increasing with every subsequent time interval; and
determining an incremental decrease in values of one of the plurality of first average temperatures and the plurality of second average temperatures with every subsequent time interval.

16. The system of claim 14, wherein the drift in values of one of the plurality of first average temperatures and the plurality of second average temperatures is determined when the values of one of the plurality of first average temperatures and the plurality of second average temperatures decrease with every subsequent time interval and the values of the other of the plurality of first average temperatures and the plurality of second average temperatures remains within a predefined threshold range with every subsequent time interval.

17. The system of claim 14, further includes:
a display device configured to:
indicate that the first module is erroneous when the plurality of first average temperatures includes the drift; and
indicate that the second module is erroneous when the plurality of second average temperatures includes the drift.

18. The system of claim 14, wherein the first location is different from the second location.

19. The system of claim 14, wherein first working temperatures at the first location against which the first corresponding temperatures are detected and second working temperatures at the second location against which the second corresponding temperatures are detected lie within a preset working temperature range during a normal working of the gas turbine engine.

20. The system of claim 14, wherein the section of the gas turbine engine corresponds to a combustor section or an intake section of the gas turbine engine.
